(19) United States
(12) Patent Application Publication
(10) Pub. No.: US 2008/0073818 A1
(43) Pub. Date: Mar. 27, 2008

(54) Apparatus and Process for Producing Extruded Plastic Foil Hose

(75) Inventors: Antal Pelcz, Budaors (HU); Tamas Illes, Lakhegy (HU); Zoltan Horvath, Lebeny (HU); Laszlo Simon, Budapest (HU)

Correspondence Address: YOUNG & THOMPSON, 745 SOUTH 23RD STREET, 2ND FLOOR, ARLINGTON, VA, 22202, US

(73) Assignee: DR-PACK 11. KFT, Biatorbagy (HU)

(21) Appl. No.: 11/661,807

(22) PCT Filed: Sep. 22, 2005
(86) PCT No.: PCT/HU05/00107

§ 371 Date: Mar. 1, 2007

(30) Foreign Application Priority Data
Sep. 22, 2004 (HU) P-04-01901

(51) Int. Cl. B29C 47/88

(52) U.S. Cl. 264/515; 425/72.1

(57) ABSTRACT

An apparatus includes an internal and/or an external multiple-stage cooling device arranged coaxially with a drawing orifice of an extruder die and having multilevel tangential outlets for the coolant to stabilize a non-stabilized section of an expanded foil hose by spiral coolant streams. The internal device includes cooling units arranged at axial distances from each other, surrounding the foil section through a gap. Each cooling unit is connected to a coolant supply of selectively adjustable temperature. The external cooling device includes at least two cooling units arranged at an axial distance from each other, surrounding the foil section through a gap. Each cooling unit is provided with tangential inlets and is connected to a coolant supply to supply the coolant of selectively and individually adjustable temperature and/or volume and/or pressure.

### FIELD OF THE INVENTION

This invention relates to an apparatus and process for continuous production of extruded plastic foil hose (tubular films) and for cooling and orienting the plastic foil hose just exiting from an extruder die in course of the extrusion of the thermoplastic foil.

The proposed solution can be used for producing blown (extended) foil hoses (tubular films) from different plastics such as low-density polyethylene's (LDPE) or high-density polyethylene's (HDPE), or even for producing shrink foil. Such plastic foil hoses may be used e.g. for packaging different products.

### BACKGROUND OF THE INVENTION

U.S. Pat. No. 6,068,462 discloses a device for the continuous production of blown foil hoses, which device is provided with an internal and an external cooling unit adjacent to the drawing aperture of the extruder die. The internal cooling unit is made up of concentric discs, which are provided with groove-like radial air outlets along their external perimeter. The external cooling unit also consists of discs, which are provided with annular radial air outlets along their internal perimeter.

As to the foil production, the temperature of the melted foil exiting from the extruder die is generally between 150° C. and 180° C.; therefore the non-stabilized foil must be cooled down relatively rapidly, in the first step to approx. 80° C. to 100° C. to make it solid, then in the second step to a storage temperature of approx. 20° C. to 25° C. in order to prevent shrinking and to prevent foil layers from sticking together, and all this before rolling up. With the above foil cooling, however, rapid and even foil cooling cannot always be ensured by the mainly axial air streams exiting through the radial outlets. This poses a particular problem at higher foil speeds as in such cases there is a relatively shorter time available for the foil cooling. This means that presently the foil cooling is a critical phase of the entire foil production technology. The maximum applicable foil speed for traditional cooling technologies is about 120 m/min, which is a hindrance to further increases of the foil production.

As regards the above apparatus, it is a problem that the external cooling device blows in the coolant into a cooling gap only at the bottom, at a part with the smallest diameter of a cooling funnel surrounding the first non-stabilized conical part of the blown foil hose through said cooling channel, where the foil speed is relatively slow, and its diameter is also small. As the foil hose progresses upwards, it extends nearly parallel with the conical funnel; its diameter continuously increases, its wall thickness becomes smaller, but its progression speed also increases.

This poses the next problem that the flow cross-section of the annular cooling gap between the foil hose and the conical funnel increases multiply by the growing diameter of the blown-up foil hose (balloon), and as the radial incoming airflow from below slows down very much and warms up rapidly, consequently the efficiency of cooling deteriorates extremely. This happens in spite of the fact that, unfortunately, the size of the cooling gap between the foil hose and the conical funnel gets reduced due to a lack of coolant, therefore an increase in the thickness of the foil should be taken into account.

In our experience, when using the above apparatus, the foil is very unstable, although actually it is the cooling air flowing at a high speed between the foil and the conical funnel that is intended “to stretch” the blown foil hose out.

In traditional foil cooling apparatuses, the maximum applicable foil speed is about 120 m/min, which is a major hindrance to further increasing productivity.

Taking a closer look at the two deficiencies mentioned above, several contradictions in the cited prior art can be noted:
The foil is accelerated and the air is decelerated and heated up, meaning that the difference between temperature and speed decreases, that everything affecting cooling, that is, the heat transfer coefficient is changing for the worse, although everything should happen the other way around (inversely);
The air flow supposed to support the foil in the upper section of the cooling funnel is blown in at the bottom of the conical funnel, so the small amount of slow and heated air flow arriving at the top of the funnel is already not suitable for this at all;
Cold air is blown at the bottom of the funnel, although air even at environment temperature would also be suitable due to the great temperature difference; on the other hand, the coolant air heats up as it goes upwards, although cooled air would actually be required at the upper sections of the cooling funnel to further cool the foil hose of lower and lower temperatures.

### SUMMARY OF THE INVENTION

The primary object of the invention is to eliminate the deficiencies mentioned above, that is, to provide an improved technology whereby the foil hose exiting from the drawing orifice of the extruder can be cooled down and stabilized more rapidly, evenly and efficiently than by traditional technologies.

A further object is to improve the quality of foil products by more rapid, even and efficient cooling. In this context, ‘quality improvement’ primarily means a reduction of foil thickness tolerance and a properly oriented texture of the thermoplastic material.

Further objects are to eliminate the upward lack of coolant in the cooling phase, and to make the volume of coolant controllable easily and selectively in the longitudinal (axial) direction; and to hold the blown foil hose (balloon) more stable during the cooling step.

Another object is to increase the productivity of foil production in general by improving the efficiency of the cooling technology.

The primary object is achieved according to the invention by providing an apparatus for continuous manufacturing extruded plastic foil hose, which comprises an extruder die suitable for forming the foil hose by its annular drawing orifice; and an internal and/or an external cooling device surrounding said drawing orifice and at least a portion of the expanded foil hose. Said internal and/or external cooling device is provided with an inlet for a coolant, preferably cooling air, connected to a coolant supply, and at least one outlet supplying coolant to a main annular gap between the expanded foil hose to be cooled and a annular skirt of said internal and/or said external cooling device. The essence of the invention lies in that, the internal and/or the external cooling device is/are formed as a multiple-stage device—arranged preferably direct on the extruder die coaxially with the drawing orifice—, and having multi-level tangential outlets for the coolant to stabilize a first conical non-stabilized section of said expanded foil hose by internal and/or external spiral coolant stream. The multiple-stage internal cooling device comprises at least two annular cooling-orienting units being arranged at axial distance from each other, surrounding internally at least partly the non-stabilized section of the foil hose through the main internal annular gap. Each of the internal annular cooling-orienting unit is connected to the coolant supply in such a way to supply the coolant of selectively and individually adjustable temperature and/or volume and/or pressure. The multiple-stage external cooling device, if any, comprises at least two annular external cooling units being arranged in axial distance from each other, surrounding externally at least partly the conical non-stabilized section of said expanded foil hose through a main external annular gap. Each external cooling-orientating unit is provided with at least one tangential inlet and is connected to a second coolant supply in such a way to supply the coolant of selectively and individually adjustable temperature and/or volume and/or pressure.

In a preferred embodiment, the apparatus is provided with at least one of said internal multiple-stage cooling device and at least one of said external multiple-stage multi-stage cooling device.

According to a further feature of the invention each of the external cooling units of said external multi-stage cooling device comprises at least one coolant-distributing ring having at least one conical mantle (baffle) surrounding the main external annular gap/channel. Furthermore, the tangential outlets are formed in said conical mantles, preferably as slots, forming inlets for the coolant around the foil hose.

In a further embodiment of the apparatus, each of the internal annular cooling-orientating units comprises at least one coolant-distributing ring and at least one conical coolant mantle surrounding the main internal annular gap, and being provided with the tangential outlets, preferably slots, forming tangential coolant inlets around the foil hose.

In a preferred arrangement, the cooling-orientating units and/or the conical coolant directing mantles of the adjacent cooling-orientating units are axially arranged in such a way to overlap each other, thereby ring-like gaps are created between the adjacent conical mantles. The mutual axial position of the mantles and thereby a flow cross-section of said ring-like gaps can be adjusted.

The conical mantle of at least one of said external cooling-orientating unit may be provided with at least one conical extension mantle of relatively smaller diameter, whose relative axial position can be adjusted in relation to the corresponding directing mantle. Thereby a ring-like gap is formed between the directing mantle and its extension mantle, and the flow cross-section thereof can be easily regulated. Through an upper free end of the gap leading to an external open airspace, so some of the already used coolant can be removed from the main external ring gap of the external multi-stage cooling device.

Preferably the flow cross-section of the ring-like coolant inlet gaps at the cooling units can be adjusted by mutual axial adjustment of the cooling rings and/or their conical directing mantles and/or—at the lowest cooling unit—by mutual axial adjustment of its cooling ring and a lower neck thereof.

In another embodiment, the mutual axial position of at least two of the internal cooling-orientating units is adjustable fixed, enabling setting their axial distances and the flow cross-section of the main internal annular gap around the foil hose.

There is such an arrangement possible, wherein the cooling-orienting units of the internal multi-stage cooling device form a common cooling ring with a common internal coolant distribution space. These units also have conical mantles/baffles and tangential outlets therein form a conical skirt of said cooling ring. The coolant distribution space is also closed by a top cover and a bottom plate. Within the coolant distribution space a built-in fan rotor is embedded rotatably and connected to a rotary drive. The conical mantles of the cooling units as well as the cover and the bottom plate jointly constitute a “fan hosing”. The integrated cooling ring is provided with an inlet for supplying coolant of predetermined temperature.

For producing foil hoses from high-density plastic material, mainly polyethylene (HDPE), the internal multi-stage cooling device may be arranged at a predetermined axial distance from the extruder die.

For shrink foil production the following arrangement can be used in the apparatus according to the invention: A first cooling device is arranged immediately over the extruder die to cool a first non-stabilized conical section of the foil hose in a predetermined degree, as required. At an axial distance from said cooling devise a heating device is located to heat up and thereby to soften again the foil material being already partially extended and oriented. Directly above the heating device a second multi-stage foil cooling and orienting device is coaxially arranged for final cooling and stabilizing the foil hose.

According to the invented process for producing plastic foil hose, the following steps are to be carried out:
(a) Surrounding at least a portion of an non-stabilized expanded section of the foil hose just exiting from a drawing aperture of an extruder die by using said external multi-stage cooling device and providing thereby a main external ring gap/channel at a radial distance from an external surface of the non-stabilized expanded conical section of the foil hose and/or by using said internal multi-stage cooling device and providing thereby a main internal ring gap/channel at a radial distance from the internal surface of the non-stabilized expanded conical section of the foil hose;
(b) Supplying coolant of selectively predetermined temperature and/or pressure and/or volume, mainly cooling air, into the external and/or internal main ring gap through axially multi-level tangential inlets and directing the tangential coolant streams onto the external and/or internal surface(s) of the non-stabilized section of the foil hose in order to cool externally and/or internally the non-stabilized section of the foil hose and thereby to stabilize its structure by means of generating at least one spiral coolant stream from the multi-level tangential coolant streams within said external and/or internal main ring gap/channel by using a centrifugal force affecting the coolant spiral streams along the external and/or internal surface(s) of the non-stabilized expanded conical section of the foil hose, and by using density and pressure differences between various parts of the spiral coolant streams.

When flat foil strips are to be made of the produced foil hose, the above process may contain an additional step of cutting up the tubular foil hose longitudinally at least at two places, forming flat foil stripes from the foil hose during or immediately after the final stage of the cooling and stabilizing step.

In order to eliminate the traditional device for blowing up the foil hose in the expansion step, the above process may contain an the additional step of using the tangential coolant flows supplied by the selectively controllable coolant supply of the multiple-stage internal cooling device for blowing up the foil hose and thereby stretching and orienting it in cross direction, too.

For shrink foil production, the process according to the invention may contain the following steps: Cooling first a non-stabilized conical section of the foil hose in a predetermined degree for stabilizing it partly only, then heating up and thereby softening again the foil material. Directly after the heating step, stabilizing the foil hose completely by using a second multi-stage foil cooling and orienting device according to the invention.

The invention based on the recognition that one of the most significant factors from the viewpoint of the thickness tolerance of the foil hose is the evenness of cooling temperature at all times. If the temperature of the melted plastic material is not even at the time of exiting from the extruder die, that is, in the upper zone of the extruder die, it would not result in foil of proper thickness tolerance even in case of complete even cooling. On the other hand, thickness tolerance will not be adequate, either, if the melted plastic material of even temperature along the perimeter exits from the die, but it would not be cooled back evenly.

According to our experimental results, similar phenomenon is brought about in both of the cases above, which explain uneven foil thickness in the prior art. At places, where relatively cooler melted plastic material exits from the extruder die and/or the cooling is more intensive and/or the air flow is colder, the foil material cools back sooner and more rapidly, and therefore these are the foil points or sections, which lose their capability of elastic stretching sooner, and therefore these points or sections remain thicker.

On the other hand, if a hotter melted plastic material exits from the extruder die and/or the cooling is less intensive and/or the cooling air flow is warmer, the melted foil material cools back later and more slowly, and these are the foil points or sections which lose their capability of elastic stretching later, and therefore these foil points or sections can continue to stretch. For this reason, the end product (the final foil hose) will be thinner than required at these places, which is also detrimental.

That is why one of the main objects of our experimental developments was to produce completely homogeneous and efficient cooling along the perimeter of the exiting foil hose. According to the invention two main prerequisites can be formulated, which would be “ideal” for foil cooling, in our opinion, as follows:
A selectively changing coolant volume demand must be complied with when going upwards along the cooling funnel (in the main cooling gap);
Coolants of various temperatures should be ensured to be blown in tangentially at different axial levels.

According to our experiments, the amount of heat transferred during a unit of time depends on the heat-transfer coefficient, the heat-transfer surface, the temperature of the heat-transferring medium, and the temperature of the foil. However, a high-capacity air coolant system is required for generating coolant air, as this air is constantly taken in from and blown back into the atmosphere. On the other hand, the heat-transfer surface cannot be altered because certain geometrical conditions and proportions must be complied with in order to obtain a quality product in the course of foil production, for instance; this means that the surface of the foil is given (constant). Thirdly, the heat-transfer coefficient can be changed within limits. In the case of air, this can primarily be influenced by the relative moisture content and flow speed of air (the relative speed difference between the foil and the air).

The degree of heat-transfer can be affected considerably by both factors. The heat-transfer coefficient of still dry air is approx. 5 W/m2K, while that of humid, intensively flowing air is approx. 250 W/m2K. Therefore, the quantity of the removed heat can be increased as much as 50 times by the heat-transfer coefficient.

Our experimental results show that the speed of the coolant gas is limited by the strength of the foil hose. Speed difference between the foil and the coolant, however, can be further increased to a surprising degree by feeding the coolant tangentially in accordance with the invention. Furthermore, centrifugal forces from the spiral coolant flow—affecting the foil hose—also have a favourable impact on the stability of the foil hose, resulting in astonishing extra technological effects.

According to our further experimental results, the speed of coolant is limited by the strength of the foil hose. However, the speed of the coolant can be effectively increased by introducing coolant flow as a tangential turbulent (spiral) whirl (vortex). Furthermore, the centrifugal force of the coolant vortex rotating in the main cooling gap/channel affecting advantageously the foil hose and the foil hose stability as well.

As regards cooling step, efficiency, i.e. adequate cooling capacity is also of great importance. The melted plastic material of the blown-up foil hose just exiting from the extruder die is stretched (oriented) in two directions: transversally and longitudinally along the cooling section; and in the meantime, a mesh-like plastic texture is produced therein.

Out of the transversal orientation is a consequence of the foil balloon being blown up, i.e. expanded. When the foil hose is blown up by compressed air of an additional device in a known manner, its diameter multiplies, therefore it is considerably stretched in the transversal direction. In the course of stretching, plastic molecules are arranged in the direction of stretching.

The other orientation direction of the foil is longitudinal, which is a consequence of the high-speed pulling-up of the foil in a known manner. In the course of pulling-up, the foil also stretches to its multiple, and its molecules are arranged longitudinally.

This stretching in two directions (orientation) produces a favourable mesh-like texture of the foil hose, if intensive cooling is intended for stabilizing (fixing) this mesh-like texture by adequately quick and efficient cooling. Without cooling, the plastic molecules in the still non-stabilized plastic material lose their orientation after a while, producing a disordered texture, and the plastic material is not solidified.

As a result of proper cooling, the plastic flux exiting through the extruder head orifice begins to stiffen, and it almost solidifies by the end of the conical cooling channel, obtaining its final thickness and stabilized state. Thus, as mentioned earlier, even and selectively controllable cooling of the proper intensity plays a major role in this.

### BRIEF DESCRIPTION OF THE DRAWINGS

The invention is disclosed in more detail on the basis of the accompanying drawings showing a few embodiments of the solution according to the invention. In the drawings:

FIG. 1 illustrates a vertical cross-section of a first embodiment of the apparatus according to the invention;

FIG. 2 illustrates a cross-section along lines II-II in FIG. 1;

FIG. 3 shows a vertical cross-section of a second embodiment of the foil apparatus according to the invention;

FIG. 4 illustrates in a diagram the differences of speed vectors at various arrangements;

FIGS. 5A-5C and 6A-6C show the simplified arrangements of the known cooling device mentioned in the introduction and that of the invention, as illustrated in FIG. 3, and their diagrams illustrating speed and temperature differences, respectively;

FIG. 7 is a cross-section of a detail of the third embodiment of the apparatus according to the invention;

FIG. 8 is a cross-section along line VIII-VIII in FIG. 7;

FIG. 9 illustrates a cross-section of a detail in FIG. 7, namely the internal foil cooling and orienting device;

FIG. 10 is a side view of the solution shown in FIG. 9;

FIG. 11 illustrates an outline of the lateral view of traditional foil producing apparatus with internal cooling;

FIGS. 12 and 13 are diagrams illustrating speed and temperature differences in the apparatus according to FIG. 11;

FIG. 14 illustrates a simplified lateral view of the embodiment of the apparatus according to the invention as shown in FIG. 7;

FIGS. 15 and 16 are diagrams illustrating speed and temperature differences in the solution according to FIG. 14;

FIG. 17 illustrates a version of the apparatus according to FIG. 7 in a vertical cross-section, which is also equipped with an external cooling device;

FIG. 18 illustrates a further embodiment of the apparatus according to the invention in a vertical cross-section, where the internal cooling-orientating device is equipped with an internal fan of bottom feed;

FIG. 19 shows a version of the solution according to FIG. 18, where upper coolant feed is applied;

FIG. 20 shows a special embodiment of the apparatus according to the invention, intended for the production of high-density polyethylene foil hoses;

FIG. 21 illustrates a further special embodiment of the apparatus according to the invention in a vertical cross-section, intended for producing shrink foil;

FIG. 22 illustrates a preferred combined embodiment of the apparatus according to the invention in a vertical cross-section, which is equipped with both a multi-level internal foil cooling-orientation device and a multi-level external cooling device.

### DETAILED DESCRIPTION OF ILLUSTRATED EMBODIMENTS

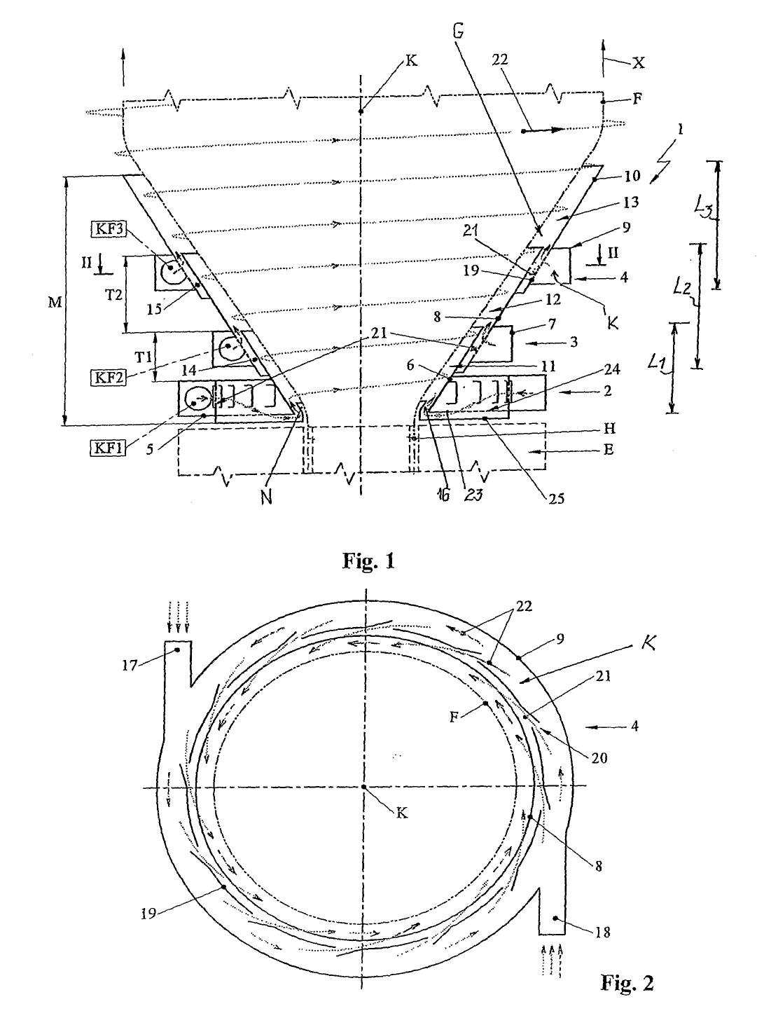

As it is illustrated in FIG. 1, the first embodiment of the foil producing apparatus according to the invention is equipped with an external foil cooling device 1 for feeding a pressurized coolant, mainly compressed and cooled air to a non-stabilized conical section M of a blown foil hose F just exiting from a drawing orifice H of an extruder die E for continuously extrusion of the foil hose F.

According to the invention the external cooling device 1 is formed as a multi-stage foil cooling device arranged direct on the extruder die E coaxially with its drawing orifice H; comprising at least two annular external cooling units arranged in axial distance from each other, that is in a progress direction X of the continuously extruded foil hose F.

In the first embodiment shown in FIG. 1, three external cooling units 2, 3, 4 are applied; these are arranged concentrically with the foil hose F above each other, looking in the direction X, with an axial distance T1 and T2 from each other, respectively. The external cooling units 2, 3, and 4 are fixed in their pre-determined axial position in an adjustable manner to each other and/or to a framework structure of the apparatus (not illustrated separately).

In the present case, the size of the distances T1 and T2 are selected to be 100 mm and 200 mm, respectively, and a height of the entire stabilization and cooling conical section M of the blown foil hose F is selected to be 600 mm.

In FIG. 1 the lower cooling unit 2 is connected directly to the upper part of an extruder die E of the foil producing apparatus, only partially indicated by a thin result line, which has as mentioned above, the circular drawing orifice H. The freshly extruded foil hose F exits through the drawing orifice H continuously, in a known manner, whose melted plastic material (e.g. polyethylene) is in an unstable plastic state as yet.

The cooling units 2, 3, and 4 of the external foil cooling device 1 according to the invention are substantially of similar design, meaning that each of them consist of a cooling ring having an internal space or canal system (not shown) distributing a coolant flow, and a conical coolant directing mantle. Accordingly, the cooling unit 2 is equipped with a cooling ring 5 and a conical directing mantle 6; the cooling unit 3 with a cooling ring 7 and a conical directing mantle 8, and the upper cooling unit 4 with a cooling ring 9 and a conical directing mantle 10. An internal space is provided in each cooling unit 2 to 4, admitting and distributing the coolant in the cooling rings 5, 7 and 9.

FIG. 1 clearly shows that the external cooling units 2, 3, and 4 are arranged concentrically with a theoretical median line K of the drawing orifice H emitting the foil hose F in a way that external conical ring-like coolant channels 11, 12, and 13 are created between their internal surface and an external mantle surface of the foil hose F for a coolant, e.g. air, and these together form a continuous external main cooling ring gap G for a spirally whirling coolant flows (designated by arrow 22) along the height of the stabilizing and cooling section M of the foil hose F.

FIG. 1 also shows that the adjacent directing mantles 6 and 8, as well as the mantles 8 and 10 are arranged with an axial overlap, and in these overlapping sections, tangential coolant inlet gaps 14 and 15 are created between the cooling rings 5 and 7 and the directing mantles 6 and 8, respectively.

The lower external cooling unit 2 has a central neck N coaxial with the conical directing mantle 6, with also a ring-like coolant inlet gap 16 between its conical surface extending upwards and the internal surface of the directing mantle 6.

According to the invention, the cross-section of the coolant inlet gap 16 can be controlled by adjusting, e.g. the relative axial position of the neck N and the directing mantle 6 at the lower external cooling unit 2. Similarly, the flow-through cross-section of the coolant inlet gaps 14 and 15 can be controlled at the cooling units 3 and 4, e.g. by adjusting the relative axial position of the coolant rings 7 and 9 and the associated directing mantles 8 and 10, respectively. In FIG. 1 the axial size of the external directing mantles 6, 8, and 10, overlapping each other, is designated by L1, L2 and L3, respectively.

The cross-section in FIG. 2 shows the structural design of the uppermost cooling unit 4 in more detail; but it is to be noted that the others have similar structure. In the present case, the cooling ring 9 of the cooling unit 4 has a trapezoidal cross-section welded from a sheet. In order to introduce pressurized tempering coolant (e.g. cooling air) into the internal space of the cooling ring 9, it is equipped with two tangential inlet studs 17 and 18 opposite to each other. The conical directing mantle 10 is a continuation, obliquely upwards, of an internal wall 19 of the cooling ring 9. The bevel-angle of the internal wall 19 and the directing mantle 10, constituting an extension of the former, e.g. 60°, is approximately identical with that of the conical non-stabilized section of the blown-up foil hose F.

The internal wall 19 of the cooling ring 9 is equipped with perforations 20 located with identical interspaces along the perimeter, which in the present case are shaped by U-shaped cuttings of the internal wall 19 and the bending out of the tongues thus produced. Thereby special lateral outlet gaps 21 are produced for leading the coolant tangentially to the foil hose F. The tangential lateral outlet gaps 21 lead into the ring-like coolant inlet gap 13 (FIG. 1).

The cooling unit 3 in the middle is also of similar design, where (see FIG. 1) the tangential lateral outlet gaps 21 lead into the ring-like coolant inlet gap 14.

The lateral wall of the cooling ring 5 of the lower cooling unit 2 is similarly equipped with tangential lateral outlet gaps 21 (FIG. 1). Furthermore, cuttings (similar to the cuttings constituting the outlet gaps 21) are provided at a bottom side 23 of the cooling ring 5, constituting lower tangential outlet gaps 24, which latter lead into the ring-like gap 16.

The spiral airflows going through these effectively cool the foil hose F continuously exiting from the drawing orifice H immediately after its exit. The bottom spiral airflows thus generated are required so that the surface of the melted plastic flux is stiffened first and the blown-up foil hose F can be pulled up. The cooling ring 5 of the lower cooling unit 2 is equipped with a cover 25 below its perforated bottom side 23.

The pressurized coolant introduced through the tangential inlets 17 and 18 of the external cooling units 2, 3 and 4 is fed into the gaps 14, 15 and 16 through the lateral outlet gaps 21 and the lower outlet gaps 24, thereby the coolant is set in spiral coolant whirling bottom-up motion in the main external ring gap G along the external mantle of the foil hose F (as indicated by thin arrows 22 in FIGS. 1 and 2). By way of the joint directing mantles 6, 8, and 10, the external cooling units 2, 3, and 4 are in a cooperating connection, meaning that the cooling air flows progressing spirally upwards effectively cool the entire height M of section to be stabilized of the foil hose F.

Therefore air is mainly blown in through the lateral outlet gaps of the external cooling units 2, 3, and 4 as well as through the gap 16 crossing the lower outlet gaps 24 of the lower cooling unit 2, and through the gaps 14 and 15 between the overlapping directing mantles 6 and 8, and 8 and 10, respectively.

The spiral tempering coolant flows in the intermediate cooling unit 3 and the upper cooling unit 4—progressing conically upwards—are intended to satisfy the continuously increasing demand of air and tempering. The lateral outlet gaps of the cooling ring 7 of the intermediate cooling unit 3 and those of the cooling ring 5 of the lower cooling unit 2 are also indicated by 21 in FIG. 1.

With this arrangement, the so far inevitable problem of traditional apparatus has been solved, namely that the cooling air blown in at the bottom slows down and heats up with the conical extension, therefore the ring gap is reduced between the foil hose F and the mantle extending conically. According to the present invention, ‘fresh’ cooling air is fed into the cooling units 2, 3 and 4, in a selectively controllable manner. Thus the size of the main external ring gap G between the foil hose F and the conically extending external directing mantles 6, 8, and 10 stays nearly constant all the time, which is of great importance as to the product quality.

Another significant additional effect of the invention is that the coolant supply of the cooling units 2, 3, and 4 of the external foil cooling device 1 comes from separate and individually controllable coolant supply HK1, HK2, and HK3 (FIG. 1). This measure enables us to change the temperature and/or pressure and/or quantity of the coolant according to current technological demands selectively and individually at the cooling units 2, 3, and 4.

At the upper cooling unit 4, for example, the quantity and temperature of the coolant blown in can be changed in a way that in the meantime they are not changed at the other places, e.g. at the lower cooling unit 2 and/or the intermediate cooling unit 3. This greatly facilitates the control and the separability of the effects of the intervention.

According to our experimental results, an ever greater quantity of increasingly colder air is required to completely and rapidly cool back the accelerating foil hose F cooling in the meantime going upwards along the conical main external ring gap G. Accordingly, the apparatus according to the invention can supply air in quantities and/or at temperatures individually regulated at the various height levels of the cooling units 2, 3, and 4 of the external cooling device 1 to the external surface of the foil hose F. Thus, the invention ensures the temperature and speed difference required for cooling of adequate intensity, actually by blowing in an ever greater quantity of increasingly colder air in a pre-determined manner, in the most even distribution possible as a result of spiral coolant flows.

A further advantage of this arrangement of the external cooling device 1 according to the invention is that coolant of different quantities and/or pressures and/or temperatures coming from the individually controlled coolant supply HK1, HK2, and HK3 (FIG. 1) can also be blown in on the basis of the parameters of the coolant already inside the device 1. This means that the temperature of the spiral coolant flows arriving from below is measured, for example in the main external conical ring gap G before the cooling units 3 and 4), then the temperature of the coolant to be fed in there is determined as a function thereof. This way the temperature difference required for appropriate heat transfer can be safely maintained in the system.

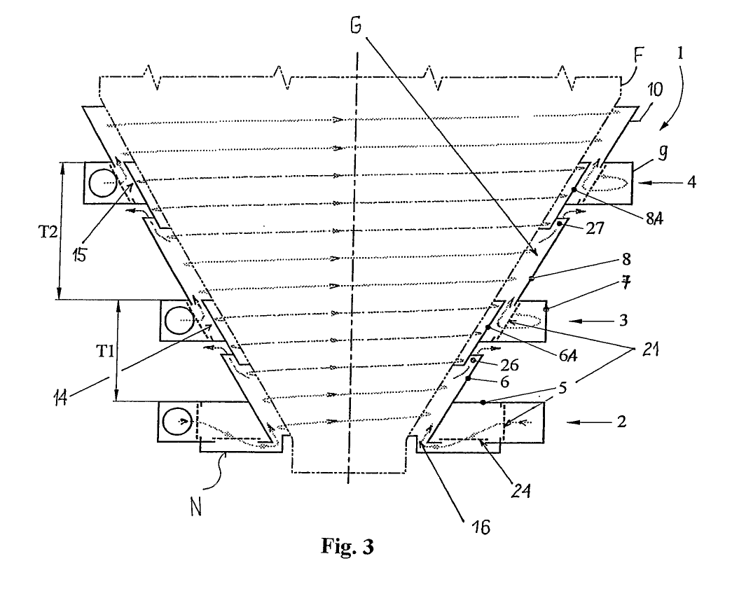

Another control possibility making controlled heating even easier is closely related to the temperature measurement above. Before introducing new coolant, it is possible to remove the heated air coming from below; examples are shown in relation with FIG. 3.

FIG. 3 shows a variant of the external foil cooling device 1 of the apparatus according to the invention which is also equipped with three external cooling units 2, 3, and 4, arranged axially with a distance T1 and T2 between them.

The structural design and arrangement substantially correspond to the ones according to FIGS. 1 and 2. The only difference is that here at an lower cooling unit 2, a conical directing mantle 6 of a cooling ring 5 is equipped with a conical extension mantle 6A of relatively smaller diameter as a continuation thereof, whose relative height position can be adjusted in relation to the directing mantle 6. Thereby the cross-section of a ring-like gap 26 between the directing mantle 6 and the extension mantle 6A can be regulated, which latter actually leads to the external open airspace. So through the outlet gap 26, some of the already used coolant can be removed from the main external ring gap G of the cooling device 1.

In a given case, the heated air arriving from below is measured by e.g. a heat sensor, and if no sufficient cold air can be mixed to it using the next cooling unit in order to achieve the desired coolant temperature, then the heated air will be led out from the ring gap (and the cooling unit 2) through the gap 26 before it reaches the intermediate cooling unit 3.

The intermediate cooling unit 3 is designed in a similar manner. Here, a conical extension mantle 8A of relatively smaller diameter is provided as a continuation of the conical directing mantle 8, and the thus generated outlet gap 27, through which some of the coolant can similarly be led to the external airspace, if necessary.

On the basis of the above, it can be conceded that the external foil cooling (tempering) device 1 for the apparatus according to the invention can be used for creating a foil cooling ‘map’ adjusted to the current product. This means that the quantity, speed and temperature of the coolant can be adjusted selectively as required at any height of the external cooling units 2 to 4, i.e. by axial sections at the blow-ins, namely the tangential inlet gaps 14, 15, and 16. This way any discretional cooling states can be generated in the knowledge of the parameters of the plastic flux and taking into consideration the characteristics intended to be achieved of the foil hose F.

This is of extraordinary importance because the mesh-like texture of the plastic material produced by blowing up, pulling up, and rotating the revolving core—in case of the extruder die with a revolving core—must be fixed, i.e. stabilized in this cooling section at the height M in a way that it should be completely even along the perimeter and the length.

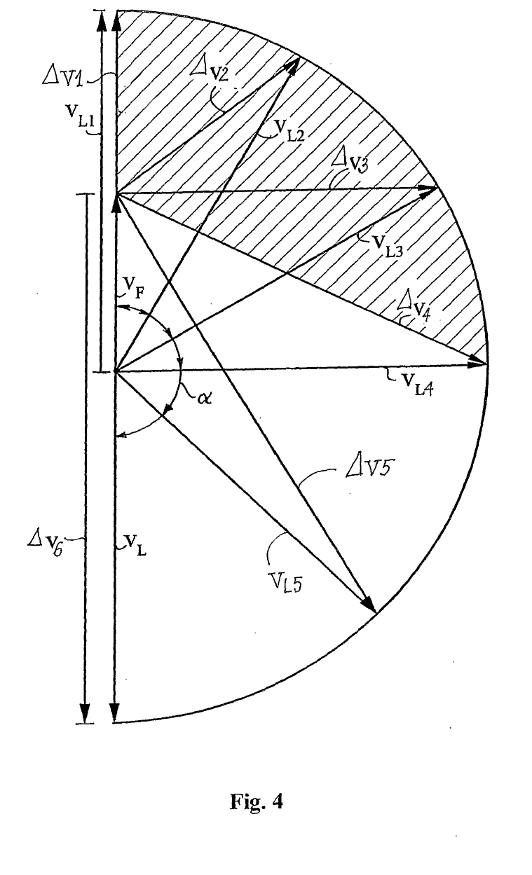

With regard to theoretical explanation of velocity vectors triangles as illustrated in FIG. 4, the flow speed of the coolant air is indicated by v_{L}, a driving speed of the foil hose F by v_{F}, an angle there-between by “α” (alpha), and a velocity difference vector by Δv.

First, let us examine an arrangement where the coolant is driven parallel with the direction of the foil hose. In this case, a speed difference Δv₁ is identical with the difference between the absolute values of the velocity vectors (Δv₁=v_{L1}−v_{F}). In other words, this means that if the speed of air v_{L1} is 100 m/min, for instance, and the speed of the foil v_{F} is 50 m/min, then the speed difference Δv₁ is about 50 m/min.

But, if the coolant is fed in an angle α, compared to the foil, then the speed difference will already be a difference of velocity vectors, which is certainly greater than the difference between the absolute velocity values (see corresponding values in FIG. 4: v_{L2} and Δv₂; v_{L3} and Δv₃; v_{L4} and Δv₄; v_{L5} and Δv₅; v_{L6} and Δv₆ (the speed of the foil v_{F} was selected as constant: 50 m/min).

The greatest velocity difference v_{Δ6} could be produced, if coolant were fed in a contrary direction to the foil (see v_{L6} and v_{F}). In this case, the absolute values would just be aggregated. In our view, practically the perpendicularity (α=90°) of the two velocity vectors (v_{L4} and v_{F}) seems to be the feasible maximum (Δv₄ in FIG. 4), therefore the speed difference Δv₄ may be relatively high, about 111 m/min, in the case of the data mentioned above.

A further significant advantage of the above embodiment is that the pressurized coolant introduced tangentially in the external cooling units 2 to 4 preserves its angular momentum along the external surface of the foil hose F, meaning that the cooling air progresses tangentially and spirally even when arriving at the foil. This is a substantial difference and advantage because at the prior cooling technology presented in the introduction, the radially introduced air progresses already parallel with the foil as it arrives at the foil because of the diverting effect of distribution canals.

In the proposed arrangements according to the invention, the significance of the air progressing tangentially or at an oblique angle compared to the foil lies in its impact on the heat transfer coefficient. If introduced tangentially, the air may considerably increase the value of the heat transfer coefficient, thereby increasing the efficiency of heat transfer. This is a very important additional effect because today—as already mentioned above—the productivity of the entire foil production and the speed of the applicable foil track is actually hindered by the efficiency and speed of foil cooling.

In the course of our experiments, it was discovered that the heat transfer coefficient can be effectively increased by the tangential introduction of the coolant into the main ring gap G. The background of this is presented below. The following known formula can be used for calculating the quantity of heat transferred per time unit:
Q=α·A(T_{F}−T_{L}), where
α—heat transfer coefficient,
A —heat transfer surface,
T_{F}—foil temperature,
T_{L}—coolant temperature.

It can be admitted from the formula above that there are actually three factors by which the quantity of the heat transferred can be modified, namely:
a) A temperature difference between the coolant and the foil wall (T_{F}−T_{L}); As an example, let the foil temperature (T_{F}) be 200° C., and that of the cooling air (T_{L}) from the environment 25° C. By cooling down the air from the environment to 5° C., the temperature difference will increase, but the change from 175° C. to 195° C. will result in a 10% efficiency increase; however, the generation of cooled air requires a costly and high-capacity air cooling system. But according to our experimental results, even this 10% efficiency increase induced by cooled air was perceptible in foil quality.
b) In order to achieve a given quality in the course of foil production, given geometrical conditions and proportions must be observed, thus the surface of the foil is given. Therefore, the value of the heat transfer surface is practically unchangeable.
c) Nevertheless, the heat transfer coefficient (α) can be changed within a wide range. In the case of air, this can be influenced primarily by the relative humidity of the air as well as by the flow speed of the air (by the speed difference between the foil and the cooling air). Both factors can considerably affect the degree of heat transfer. The heat transfer coefficient of still dry air is approx. 5 W/m²K, while the heat transfer coefficient of humid, intensively blown air may even be as high as 250 W/m²K. From this it follows that the quantity of heat abstracted can be increased to even 50-fold by the heat transfer coefficient.

Of course, the speed of air is limited by the strength of the foil hose F. However, cooling efficiency can be further increased as speed is increased through a vortex-like introduction and flow of air. Furthermore, the centrifugal force of the air vortex (spiral coolant flow) affecting the foil hose benefits foil hose stability as well.

In the knowledge of the review of the heat transfer coefficient and the solution according to the invention, it is easy to compare the traditional cooling ring with the solution regulated at various levels according to the invention. As mentioned above, the temperature difference and the relative speed difference are the most important factors from the viewpoint of heat exchange, i.e. foil tempering, because these are the two factors, which affect the heat transfer coefficient in a modifiable manner.

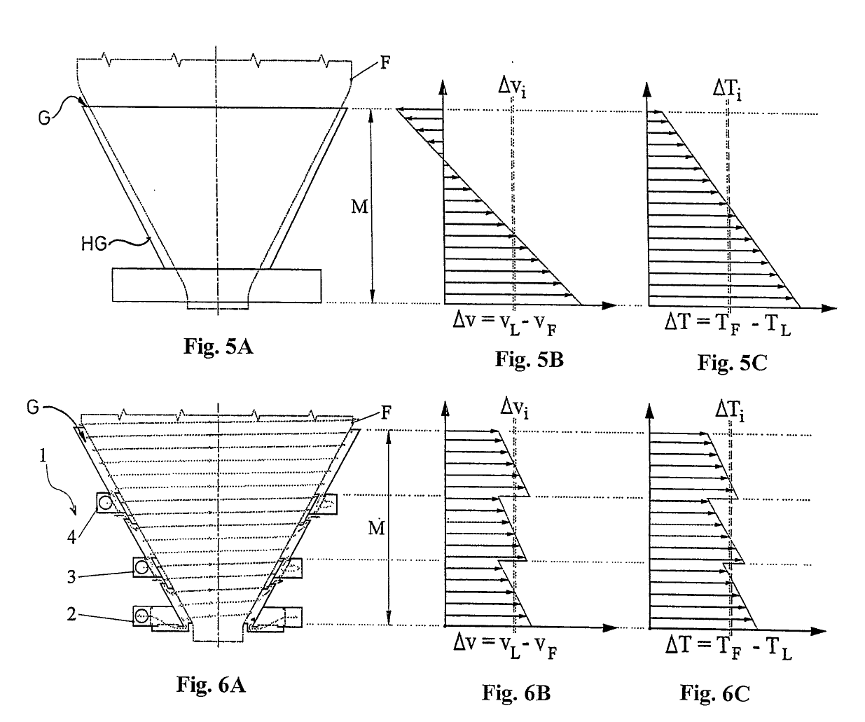

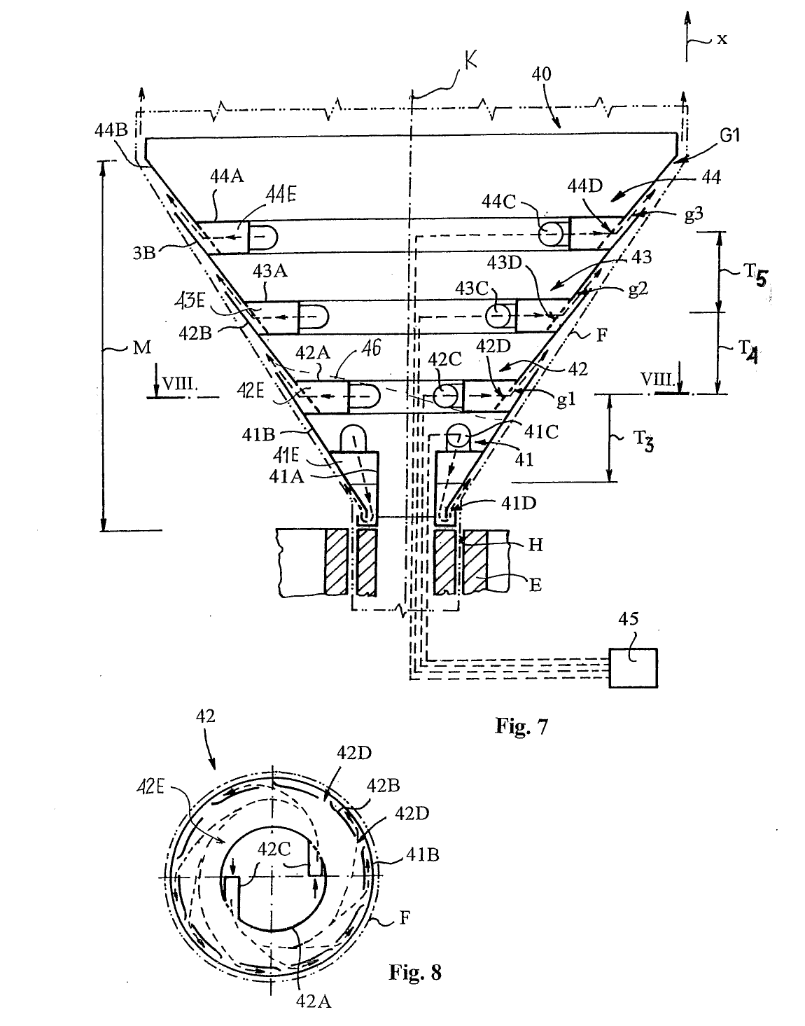

For the sake of comparison, FIGS. 5A to 5C and 6A to 6C illustrate the changes of these factors in a diagram, going upwards along the external conical ring gap G, in the entire height of cooling and stabilization section M, in the case of both the traditional (FIG. 5A-5C) and the multi-level regulated external foil cooling structure according to the invention (FIG. 6A-6C).

FIG. 5A shows a traditional solution, with an external cooling cone HG, a foil hose F and a height of the cooling-stabilizing section M of the foil hose F. For the diagram in FIG. 5B, a horizontal axis shows the speed difference (Δv) to be achieved with the traditional solution, while the vertical axis shows the height M of the cooling section; and for the diagram in FIG. 5C, the horizontal axis shows the temperature difference (ΔT), while the vertical axis also shows the height M of the cooling section.

FIG. 6A shows a cross section of the external foil cooling device 1 pertaining to the apparatus according to the invention (see FIG. 3), equipped with the external cooling units 2, 3, and 4; FIGS. 6B and 6C show the speed and temperature differences as a function of the height M of the cooling-stabilizing section of the foil hose F. FIGS. 5B and 5C as well as 6B and 6C also indicate an ideal speed and temperature differences (Δvᵢ; ΔTᵢ) to be considered ideal from the viewpoint of cooling, therefore substantial differences between the two designs are obvious.

The diagram in FIG. 5B shows that the speed difference (Δv) between the air speed (v_{L}) and the foil speed (v_{F}) is eliminated at approximately a ⅔ part of the height M; moreover, by the time the foil hose F exits from the cooling cone HG, it progresses more quickly than the cooling air going parallel with it. On the other hand, it is clear for a skilled person that a certain speed would be absolutely necessary from the viewpoint of heat transfer. The flux exits slowly through the drawing orifice of the extruder die; however, the cooling air speed is high here (v_{L}). The foil accelerates very much while going upward (v_{F}), but the cooling air slows down due to the extension of the funnel (v_{L}).

On the contrary, by applying the multi-stage external foil cooling device 1 according to the invention (FIG. 6A-6C) the cooling air blown in by different levels continuously supplements the deficiency arising from the extension of the main external ring space G and some drop in the speed difference (Δv) can only be observed between the two respective cooling units.

In the external foil cooling device 1 (see FIG. 6A), three individually and selectively controllable cooling units 2-4 were presented as an example (like FIG. 1), but theoretically a discretionary number of cooling units, i.e. tempering levels can be applied. The greater the number of the ring-like cooling units over each other, the more even the speed difference can be made (see FIG. 6B), and the closer the ideal state (Δvᵢ; ΔTᵢ) can be approached.

The explanations on the diagrams for speed difference almost entirely apply to temperature differences (FIGS. 5C and 6C) as well. According to FIG. 5C, the temperature (T_{F}) of the foil is still very high when the foil exits and a great temperature difference (ΔT) is produced, compared to the cooled air freshly blown in. This significant temperature difference is eliminated while going upwards, therefore the foil hose can hardly cool back completely, only incidentally.

On the contrary, in the case of the solution according to the invention (see FIG. 6C) the air freshly blown in not only supplements the deficiency of air due to the expansion of space, but it also maintains the temperature difference (ΔT) over a desired level. If the temperature (T_{L}) of the cooling air arriving in a spiral vortex from below to the next cooling unit in the line—i.e. the blow-in level—is already too high, it can be led out from the cooling unit to the environment immediately before blow-in. Of course, this way a larger amount of cooling air must be supplemented, but in a given case it is certainly an effective and efficient solution for achieving an appropriately selectively controlled foil cooling/tempering effect.

The main benefits brought about by tests with the prototypes of the embodiments above of the external foil cooling/tempering device 1 according to the invention are as follows:
The foil balloon cools down more rapidly and safely than in the traditional manner to the effect of the cooling air blown in tangentially through the multi-level cooling units and enforced to flow in a spiral manner;
As a result of the cooling air continuously supplemented at each level, the air in the conical external main ring gap G does not heat up excessively and its cooling effect can be stabilized;
The distribution of cooling air is absolutely even along the perimeter of the foil hose F in the conical main ring gap G, throughout the entire height M;
Going upwards along axially, the size of the main ring gap G can be maintained at a permanent value;
The foil hose is kept highly stable by the cooling air flowing tangentially at a relatively high speed in the external main ring gap G between the foil hose F and the cooling units; this can also be observed from the fact that formerly, when traditional cooling rings were applied, the foil hose was very sensitive to external impacts in the system (e.g.: draught), and it was torn easily. However, at the solution according to our invention, the foil hose does not get unstable, does not start “to swing” and does not get torn even in the case of deliberate external effects (e.g. draught).

Let us mention that air was indicated as an example for coolant in the above disclosure, but in a given case it can be any other gaseous agent, such as nitrogen, neon, helium, or argon, etc.

It has not been illustrated separately, but it is obvious for the expert having ordinary skill in this art from the above explanation how each of the external cooling units 2 to 4 can be connected to a coolant source of individually controllable pressure and supply volume (e.g. a fan unit associated with a heat exchanger) which can then be controlled selectively from a central control panel (not illustrated), e.g. as a function of the control signals of heat sensors, in accordance with current technological parameters and/or producer demands.

According to the invention, at least two or more such external cooling units can be applied. Obviously, the cooling units 2 to 4 of the external foil tempering device 1 according to the invention must be arranged in the section of height M along the track of the freshly exiting and blown foil hose. In a given case, the lowermost cooling unit 2 can be cooled by air from the environment. Moreover, it is possible to have an embodiment where a warm tempering agent is pumped into at least one of the cooling units.

FIGS. 7 to 10 illustrate a third embodiment of the apparatus according to the invention for the production of a plastic foil F, whose extruder die E—illustrated only as an outline—with its drawing orifice H is to form the foil hose F. The foil hose F just exiting from the drawing orifice H passes over to a section cylindrical at the top after the conically extended and still not stabilized section having a height M. The still melted plastic is actually stabilized along this conical section M. The progress direction of pulling upwards of the foil hose F is indicated by ‘x’, the median line of the drawing orifice H by K, which substantially coincides with the theoretical longitudinal median line of the foil hose F.

FIG. 7 illustrates the embodiment of the apparatus according to the invention having an internal cooling only, which is designed as a multi-level foil cooling-orienting device 40. In the present case, this internal foil cooling-orienting device 40 is arranged in the immediate area of the drawing orifice H.

According to the invention, the internal cooling-orienting device 40 is equipped with at least two internal ring-like cooling units, arranged in adjustment to the non-stabilized conical section M of the foil hose F through a cooling main ring gap G. The internal cooling units arranged in axial distance from each other, that is in a progress direction x of the continuously extruded foil hose F.

According to FIG. 7, the multi-stage internal cooling-orienting device 40 has four internal cooling units coaxially arranged over each other; out of which a cooling unit 41 is arranged directly over the extruder die E; over this a second cooling unit 42 is arranged with an axial distance T₃; over this, a third cooling unit 43 is arranged with an axial distance T₄, and over this, a topmost fourth cooling unit 44 with an axial distance T₅ is located.

FIG. 7 shows that the internal cooling units 41 to 44 are of ever larger diameter while going upward, therefore they follow the non-stabilized conical section M of the foil hose F through the main ring gap G with a substantially identical gap size. Each of the cooling units 41 to 44 is connected separately to an integrated coolant supply 45 transporting a coolant for each cooling units 41 to 44, of individually controlled pressure and/or temperature and/or quantity, to be detailed below.

Pursuant to the invention, the cooling units 41 to 44 have at least one coolant distributor, a cooling ring arranged transversally to the progress direction x of the foil hose F. In the embodiment according to FIG. 7, each of the cooling units 41 to 44 has a separate cooling ring 41A, 42A, 43A, and 44A, respectively, and at least a coolant directing mantle 41B, 42B, 43B, and 44B, respectively, constituting an external side of the cooling unit and thereby enclosing the main ring gap G from the inside.

Each of the internal cooling units 41 to 44 has two inlets displaced at 180° from each other, indicated by reference signs 41C, 42C, 43C, and 44C, respectively, which, in the present case, are connected to the common, but individually controllable coolant supply 45. Therefore, the temperature and/or pressure and/or quantity of the coolant fed in through them is individually and selectively controllable for each cooling units 41 to 44 according to the actual technological demands.

In the present case, each of the cooling rings 41A to 44A of the cooling units 41 to 44 are equipped with a circular coolant distribution space 41E, 42E, 43E, and 44E, respectively, each of which are connected to corresponding outlets 41D, 42D, 43D, and 44D, ensuring tangential coolant flows compared to the foil hose F. In the present case, the outlets 41D, 42D, 43D, and 44D are formed as elongated slots.

Through the tangential outlets 41D to 44D, tangential coolant flows are generated which form a common internal spiral coolant flow 46 in an internal main ring gap G1, and progress from the bottom to the top along the internal surface of the non-stabilized conical section M of the foil hose F (see FIGS. 7 and 10), thereby cooling it evenly and effectively.

In the embodiment according to FIG. 7, the adjacent cooling units 41 to 44 are fixed overlapping each other, concentrically, and axially adjustably compared to each other. Thereby ring-like gaps g1, g2, and g3 with an adjustable flow cross-section are created along the overlapping parts between the adjacent conical directing mantles 41B to 44B, through which controllable tangential coolant flows exit through the outlets 41D to 44D, as illustrated by arrows with thin result lines.

In the arrangement according to FIG. 7, the cooling units 41 to 44 are fixed in their axial mutual position with the distances T₃ to T₅ which being adjustable, thereby the flow cross-sections of the main internal ring gap G1 and the gaps g1, g2 and g3 can be adjusted to pre-determined values. Thus the cooling efficiency can be further improved.

Although FIG. 7 illustrates only the single coolant supply 45 but with several individually controllable outlet channels, in a given case, each of the cooling units 41 to 44 can be equipped with a separate coolant supply. In such a case, each of them can convey coolant of individually controllable pressure and/or temperature and/or quantity to the corresponding cooling unit pursuant to the invention.

FIG. 8 illustrates the structural design of the cooling unit 42 in a cross-section. Here it can be clearly observed that the outlets 42D ensuring tangential air flows are produced, in the present case, from the parts cut out and bent out from the conical directing mantle 42B. Thus the outlets 42D, ensuring the tangential flows of the coolant, are provided at identical distances from each other along the perimeter. Let us note that the outlets 42D ensuring tangential coolant flows can also be constructed in any other way. At cooling units 43 and 44, the structural design is similar.

However, in the case of the lowermost internal cooling unit 41, FIG. 7 shows that the tangential outlets 41D are provided with in the lower part, along the perimeter of the cooling ring 41, so that the foil hose F just exiting from the drawing orifice H receives effective internal cooling flows immediately during and after its exit.

Let us emphasize that it is a further characteristic feature of the embodiment according to the invention as in FIGS. 7 and 8 that no extra foil-blowing device (essential for any traditional apparatus) is required, because the foil hose F can be blown up to the expanded shape required by the multi-level internal foil cooling-orienting device 40, that is, by its coolant flows, simultaneously with cooling and orienting. By blowing up the foil hose F, the material of the foil hose F is stretched and guided transversally to the rate required by way of the tangential coolant flows exiting from the cooling units 41 to 44. So the traditional foil blowing device necessary can be abandoned, thereby simplifying the apparatus.

At the internal foil cooling and orienting device 40, the coolant directing mantles 41B to 44B of the cooling units 41 to 44 are conical, funnel-like elements, with their bevel-angle in the present case selected as e.g. 60°; however, that in a given case, the bevel-angle of the adjacent directing mantles 41B to 44B can also be selected as a different value for the lateral stretching and orientation of the non-stabilized conical section M of the foil hose F.

The method of fixing of the cooling units 41 to 44 applied in FIG. 7 is not presented in detail; it is only remarked that their relative axial position is adjustable and a discretionary method of fixing can be applied therefore. The cooling units 41 to 44 can be fixed, e.g. to the extruder die E or to a central frame of the apparatus (not illustrated).

FIG. 7 does not illustrate a known at least one pair of pinch rollers of the apparatus, which is intended to pull the already stabilized foil hose F upwards in the progress direction x for known rolling and further processing of the stabilized foil hose F.

It can be observed from the arrangement according to FIG. 7 that the cooling units 41 to 44 can supply tangential coolant flows of previously adjusted quantities, pressures, and temperatures by height levels to the internal surface of the foil hose F. Naturally, the more cooling units are applied over each other in the foil cooling and orienting device 40, the more even cooling will be.

As to the apparatus according to FIGS. 7 to 10, the significance of the multi-level internal cooling and orienting device 40 actually lies in the fact that it effectively cools the foil hose F where transversal and longitudinal orientation is performed, namely from the exiting flux phase to the end of the stabilization section M. This arrangement brings about a particular advantage, namely that cooling intensity can be continuously increased from the starting melted flux phase of the plastic material to the completely stabilized and cooled state of the foil, that is, stabilized state of the foil hose.

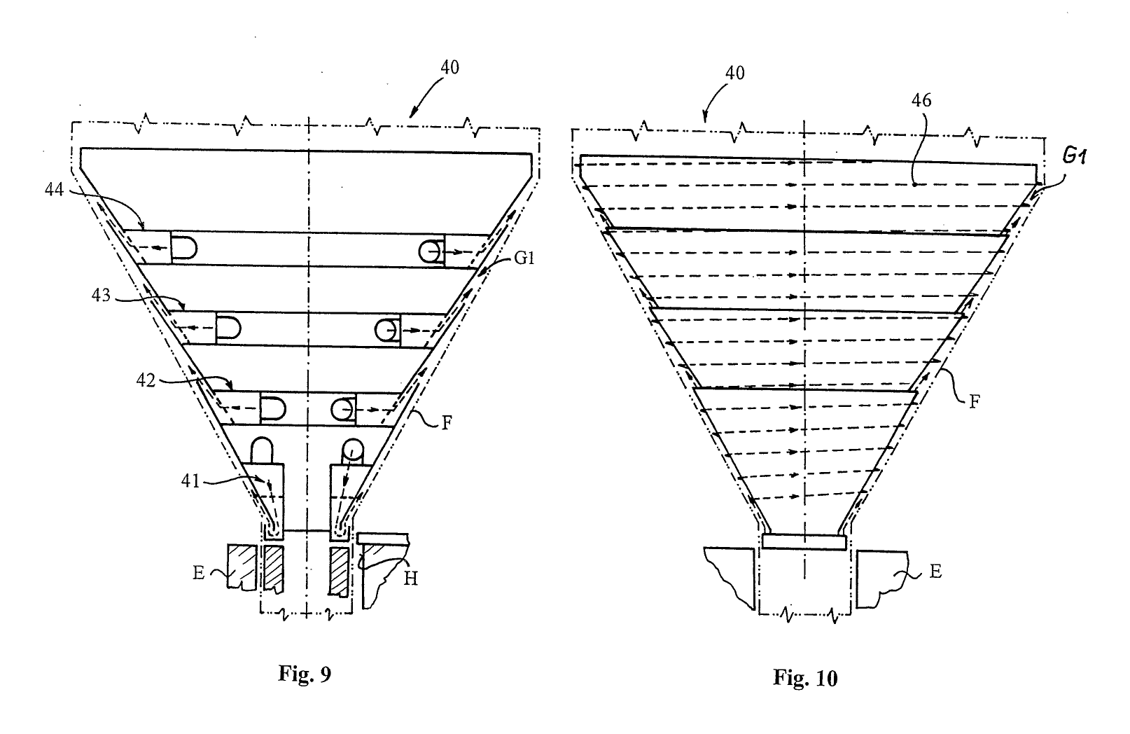

The conical surface of the coolant directing mantles 41B to 44B properly conducts tangential coolant flows from the inside and directs them to the internal surface of the foil hose F, producing the common internal spiral coolant flow 46 in an main internal main ring gap G1 (FIG. 9), therefore the coolant only flows where it is expressly required for cooling, so the cooling-stabilizing process will be more intensive and controlled.

A further substantial advantage of the spiral internal coolant flow 46 generated from tangential air flows is that it drives the foil hose F; therefore the foil hose F can be “supported” and oriented by the regulated spiral air flow 46. Another substantial advantage is that multi-level coolant blow-in eliminates coolant deficiencies in the non-stabilized conical section M of the foil hose F (which is inevitable in traditional solutions and resulting in weaker cooling).

For the sake of better understanding, FIGS. 9 and 10 illustrate the solution according to FIG. 7 in a cross-section and in an elevation, respectively. FIG. 10 clearly shows the internal spiral coolant flow 46 progressing from the bottom to the top, generated by the internal foil cooling and orienting device 40 in the internal main ring gap G1 along the internal surface of the foil hose F.

Before presenting further embodiments, let us explain in more detail the internal cooling method according to the invention below.

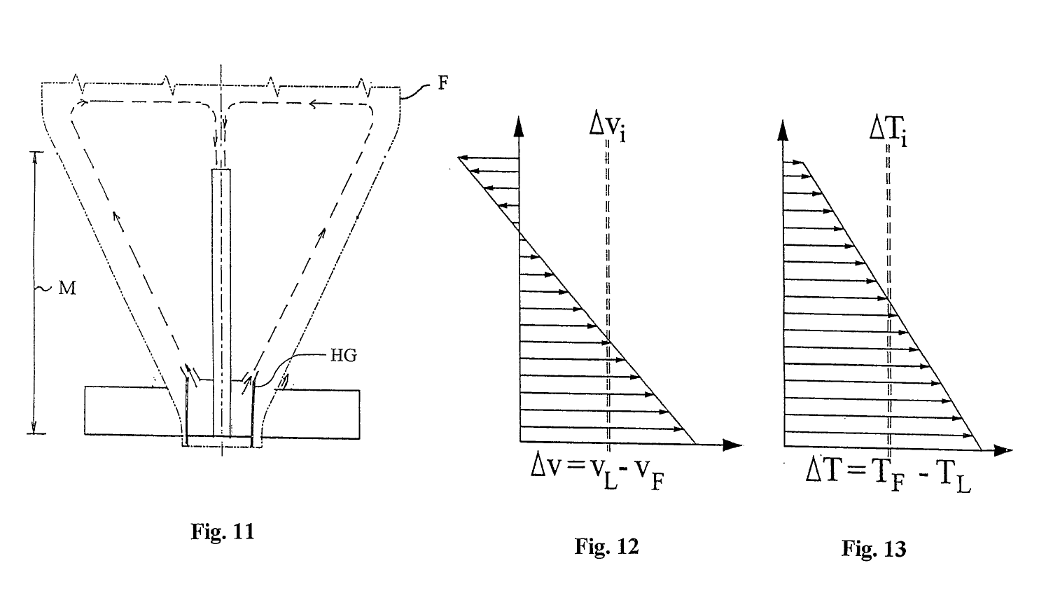

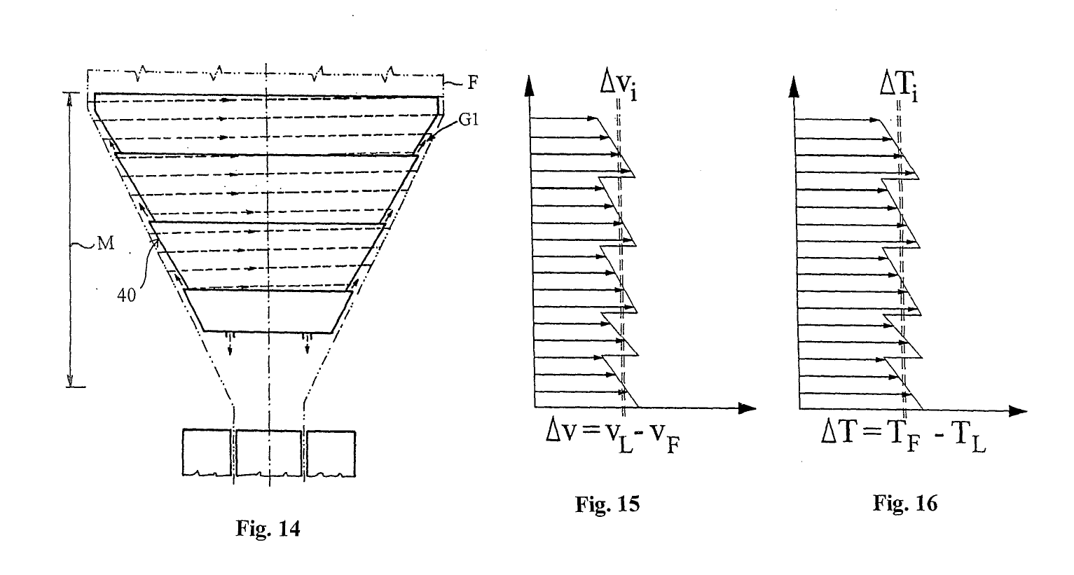

For the sake of comparison, FIGS. 11 to 13 and 14 to 16 illustrate the changes of temperature and speed in an elevation and a diagram, going upwards along the ring gap, in the entire height of cooling and stabilization section M of the foil hose F, in the case of both the traditional (FIGS. 11 to 13) and the multi-level internal cooling device according to the invention (FIGS. 14 to 16).

FIG. 11 shows the traditional internal cooling, with a cooling ring HG, a foil hose F, and a height M of the cooling section. For the diagram in FIG. 12, the horizontal axis shows the speed difference (Δv) to be achieved with this traditional solution, while the vertical axis shows the height of the cooling section M. For the diagram in FIG. 13, the horizontal axis shows the temperature difference (ΔT), while the vertical axis shows the height M of the cooling section.

FIG. 14 shows the cooling and orienting device 40 of the apparatus according to the invention (as in FIG. 7). FIGS. 15 and 16 show the speed and temperature differences (Δv; ΔT) as a function of the cooling section M. FIGS. 12, 13 and 15, 16 also indicate the speed and temperature differences to be considered ideal from the viewpoint of cooling (Δvᵢ; ΔTᵢ), therefore substantial differences between the two designs are obvious.

The diagram in FIG. 12 shows that the speed difference (Δv) between the air speed (v_{L}) and the foil speed (v_{F}) is eliminated at approximately a ⅔ part of the height M. By the time the foil hose F exits from the cooling ring H, it progresses more quickly than the cooling air going parallel with it. However, a certain speed would be absolutely necessary from the viewpoint of heat transfer. The melted plastic flux of the foil exits slowly through the drawing orifice of the die; however, the cooling air speed (v_{L}) is high here. The foil accelerates very much while going upward, but the cooling air (v_{L}) slows down due to the extension of the funnel.

On the contrary, in our invention the regulated tangential coolant flow blown in by different levels continuously satisfies the coolant demand arising from the extension of the internal main ring space G1 and some drop in the speed difference (Δv) (FIG. 15) and in the temperature difference (ΔT) (FIG. 16) as compared to the ideal nominal value (Δvᵢ, ΔTᵢ) can only be observed between the two by two respective cooling units of the device 40.

At the embodiment presented above of the multi-level internal foil cooling and guiding device 40 of the apparatus according to the invention, four individually and selectively controllable cooling units 41 to 44 were presented as an example, but theoretically a discretionary number of cooling units, i.e. tempering levels can be applied. The greater the number of the ring-like cooling units over each other, the more even the speed difference can be made, and the closer the ideal state can be approached.

The explanations on the diagrams for speed difference almost entirely apply to temperature differences (FIGS. 13 and 16) as well. According to FIG. 13, the temperature (T_{F}) of the foil is still very high when the foil exits and a great temperature difference (ΔT) can be measured, compared to the temperature of the cooled air freshly blown in. This significant temperature difference (ΔT) is quickly eliminated while going upwards, therefore the foil hose F can hardly cool back completely, only incidentally.

In contrast, according to the invention the air freshly blown in not only supplements the deficiency of air due to the expansion of space, but it also maintains the temperature difference (ΔT) over a desired level (FIG. 16). If the temperature of the cooling air (T_{L}) arriving in a spiral vortex from below to the next cooling unit in the line (i.e. the blow-in level) is already too high, it can be led out from the cooling unit to the environment immediately before blow-in (e.g. through any of the gaps g1 to g3, see FIG. 7; in such a case, some of the gaps g1 to g3 are applied as coolant blow-in and the others as coolant extraction gaps). Of course, this way a larger amount of air must be supplemented, but in a given case it is certainly an effective and efficient solution for achieving an appropriately selectively controlled cooling effect.

The main benefits brought about by tests with the prototypes according to FIGS. 7 to 10 of the apparatus according to the invention are as follows:
The foil hose F cools down more rapidly and safely than in the traditional manner to the effect of the coolant blown in tangentially through the multi-level internal cooling units and enforced to flow in a spiral manner;
As a result of the cooling air continuously supplemented, the air in the internal main ring gap G1 does not heat up excessively and its cooling effect can be stabilized;
The distribution of the coolant is absolutely even along the perimeter of the foil hose F in the internal main ring gap G1;
Going upwards along the generator of the cone, the size of the internal main ring gap G1 can be maintained at a permanent value;
The foil hose F is kept highly stable by the coolant flowing tangentially at a relatively high speed in the internal main ring gap G1 between the foil hose F and the cooling units: the foil hose does not get unstable, does not start “to swing” and does not get torn even in the case of deliberate external effects (e.g. draught).

It is to be noted that the internal foil cooling-orienting device according to the invention can also be combined with an external cooling device in a given case, further improving cooling efficiency; an example thereof will be described below.

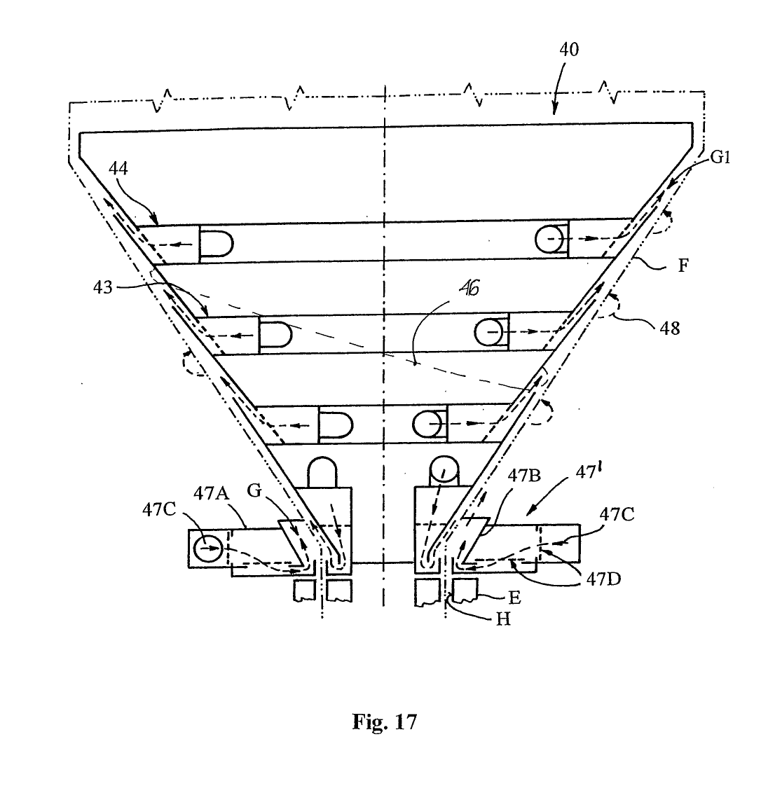

FIG. 17 illustrates a preferred embodiment of the foil producing apparatus wherein the internal foil cooling and orienting device 40 according to FIG. 7 is combined with a simple external cooling device 47′. This external cooling device 47′ is arranged immediately over the extruder die E and fixed in its position. Its structural design theoretically corresponds to that of the internal cooling units 41 to 44, that is, it is equipped with a cooling ring 47A enclosing a distribution ring space, which is provided with two tangential inlets 47C connected to a regulated coolant supply (not illustrated).

The external cooling device 47′ is equipped with a conical coolant directing mantle 47B which approaches the external surface of the foil hose F from the outside with the external main ring gap G in the section immediately after the exit of the foil. FIG. 17 shows that the external cooling ring 47A is equipped with a coolant directing mantle 47B, inlets 47C and tangential outlets 47D along its perimeter at its sides and bottom, whose design corresponds to that of the cooling unit explained in relation to FIG. 8.

So, the coolant flows exiting through outlets 47D start to move in a tangential vortex along the external mantle of the foil hose F, generating an external coolant flow 48 by going upwards in a spiral fashion.

The efficiency and evenness of foil cooling can be considerably improved by combining the internal spiral cooling flow 46 with the external spiral cooling flow 48 (FIG. 17).

It is to be noted that the internal multi-stage cooling device 40 according to the invention can be associated with any of the known external cooling devices, too.

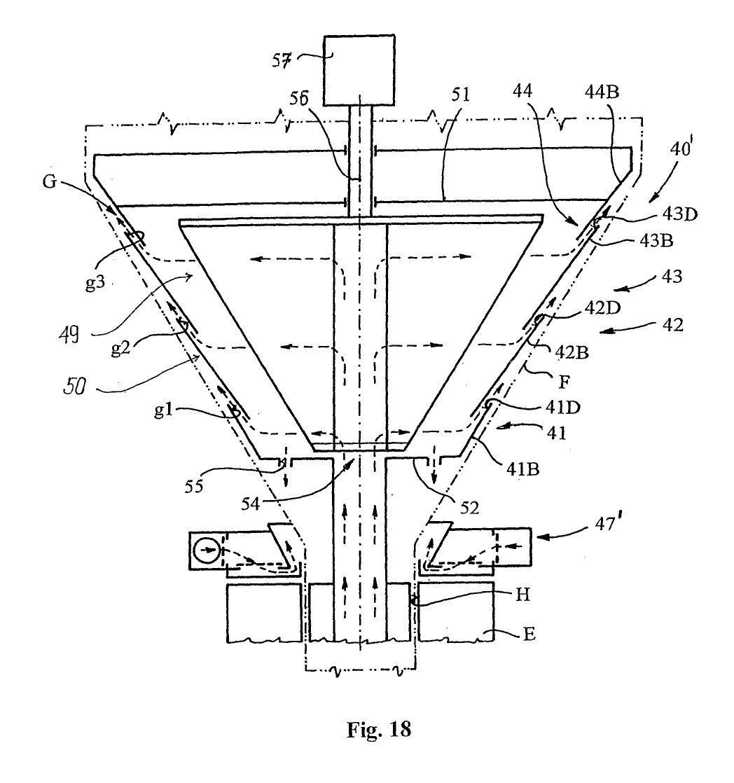

FIG. 18 shows a further embodiment of the apparatus according to the invention where the design of the internal foil cooling and orienting device is different from the embodiment mentioned above, and the apparatus is also provided with a simple external cooling device 47′ (like in FIG. 17).

The internal foil cooling and orienting device 40′ consists of cooling units 41 to 44 arranged at axial distances from each other; therefore their conical mantles are indicated by reference signs 41B, 42B, 43B, and 44B, and their tangential outlets by 41D, 42B, and 43D, respectively. However, there is a substantial difference from the embodiments presented above that here all the cooling units 41 to 44 have a single common internal distribution space 49, which is closed laterally by the mantles 41B to 44B and by a cover 51 at the top and a bottom plate 52 at the bottom.

In the coolant distribution space 49 there is a built-in fan rotor 53 embedded in a rotating manner, sucking in and distributing the coolant evenly. The directing mantles 41B to 44B of the cooling units 41 to 44 as well as the cover 51 and the bottom plate 52 jointly constitute a fan cabinet and an integrated cooling ring (50).

In the present case, this fan cabinet/house is provided with an axial inlet 54 to introduce a coolant of regulated temperature. Besides the tangential outlets 41D to 43D communicating with the space 49, the bottom plate 52 is equipped with additional tangential outlets 55, which latter provide a tangential airflow downwards (indicated by arrows) to cool the inside of the foil hose F just exiting. A shaft 56 of the fan rotor 53 is connected to a 57 rotary drive, which is an electric motor with controllable rpm.

Therefore, in FIG. 18 the internal fan is used as an internal coolant resource, which distributes the coolant completely evenly along the perimeter, therefore only an external conditioned air source must be connected to its inlet 54 (not illustrated).

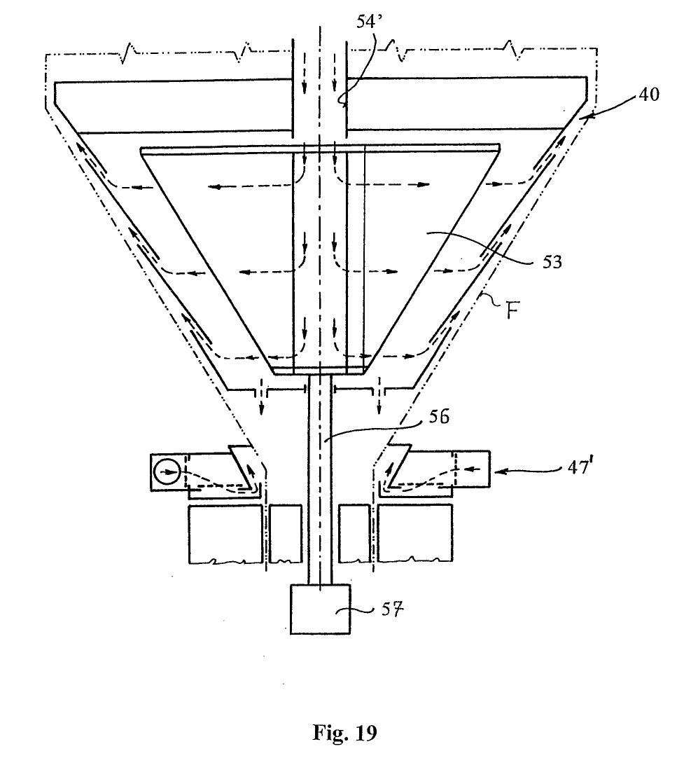

FIG. 19 shows a version of the embodiment according to FIG. 18, where a fan rotor 53 is driven at the bottom through a shaft 56 by a rotary drive 57. Another difference is that here an upper fun inlet 54′ is applied for the coolant. Otherwise, the embodiment according to FIG. 19 substantially corresponds to that in FIG. 18.

In case of applying the solution according to FIG. 19, the already stabilized foil hose F can be split at the top into two or more strips. In another possible application, internal circulation can be provided for the coolant in the foil hose F (not illustrated separately).

Let us note that particularly in the embodiments according to FIGS. 7, 18 and 19 it can be expedient to arrange the conical coolant directing mantles 41D to 44D in a replaceable manner, where directing mantles of various bevel angles can be applied, which can be replaced in accordance with current manufacturing technology demands.

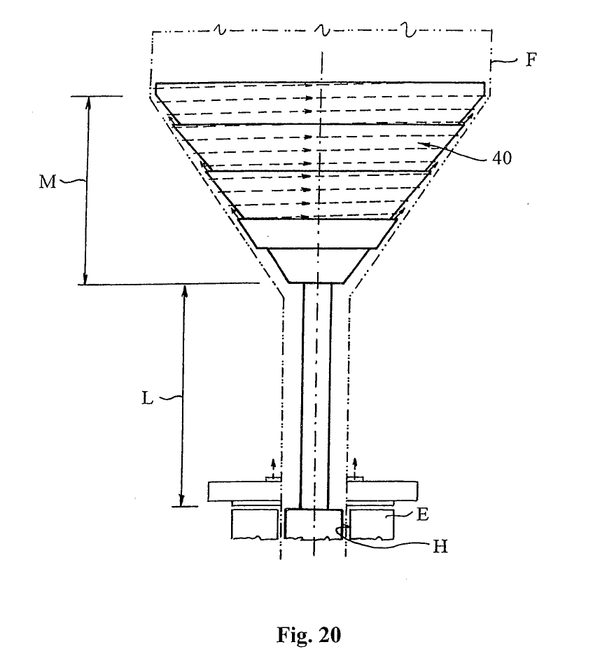

FIG. 20 shows a further embodiment of the apparatus according to the invention, suitable for producing foil hoses from high-density polyethylene (HDPE). A characteristic of this material is that the material of the foil hose F exiting from the extruder die E is still too strong to be extended and oriented by blowing up. For this production mode a multi-level internal foil cooling and orienting device 40 (as presented in FIG. 7) according to the invention is arranged over the extruder instrument E at an axial distance L in order to elongate first the foil hose F to a required length after exiting through the drawing orifice H, and then using the foil cooling and orienting device 40 for cooling and completely stabilizing the foil hose F along the stabilizing section M.

The value of the distance L was selected as 4 to 5 times the diameter of the foil hose F exiting through the drawing orifice H, which is approx. 400 to 500 mm (in case of a foil hose of 100 mm diameter).

By using this apparatus, substantially no stabilization is actually performed along the distance L. The freshly extruded foil hose F is only stretched or elongated only first by a known upper foil pulling cylinder pair (not illustrated), then the foil cooling and orienting device 40 according to the invention is operated (in a given case, together with an external cooling device). Thereby the cooled and oriented and blown-up foil hose F is finally stabilized along the stabilizing section M with a final diameter.

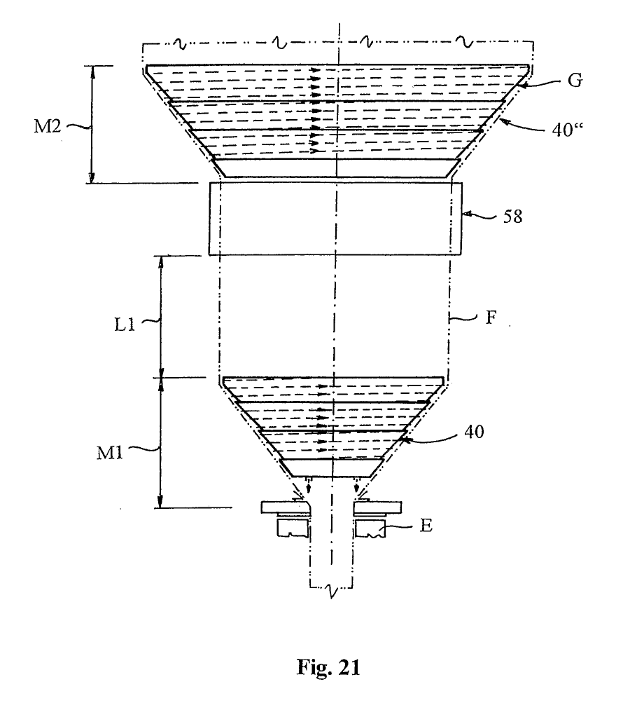

FIG. 21 shows yet another embodiment of the apparatus according to the invention, suitable for producing shrink foil of high shrinking capacity. The presentation above indicated that the internal foil cooling and orienting device 40 of the apparatus according to the invention substantially “divides” the foil hose F (“balloon”), i.e. the blown-up foil hose F into sections inside as the coolant can only exit through a specified flow cross-section of the predetermined main ring gap G1.

Actually, due to the same “sectioning”, in case of the arrangement shown in FIG. 21, and similarly to the solution according to FIG. 7, a primary foil cooling and orienting device 40 is arranged immediately over the extruding die E, in order to cool a first section M1 of the foil hose F for partially stabilizing it, to the degree required. At a pre-determined axial distance L1 from the upper edge thereof, an annular heating device 58 is located coaxially, designed to heat up and thereby soften again the foil hose F partially extended and oriented. Directly above the heating device 58, there is arranged a second foil cooling and orienting device 40″, which structurally corresponds substantially to the first foil cooling and orienting device 40.

The softened and repeatedly blown-up foil hose F is extended within a second stabilizing section M2 to reach the final diameter in the secondary foil cooling and orienting device 40″. At the same time, it is finally stabilized along the section M2 by effective cooling. Thus, shrink foil with high shrinking capacity can be produced without closing the foil hose F at the top and repeatedly blowing it up at a high productivity rate and yielding good product quality. Such shrink foils can be applied as fine shrink foils, e.g. as bulk packaging or shrink foil holding drink bottles together.

In the apparatus according to FIG. 21, any of the internal foil cooling and orienting apparatus 40 and/or 40″ can be combined in various ways with traditional external cooling solutions, including cooling rings, cooling cones, or preferably with any of the external foil cooling devices 1, 47 according to the invention, but it can also be applied individually, too.

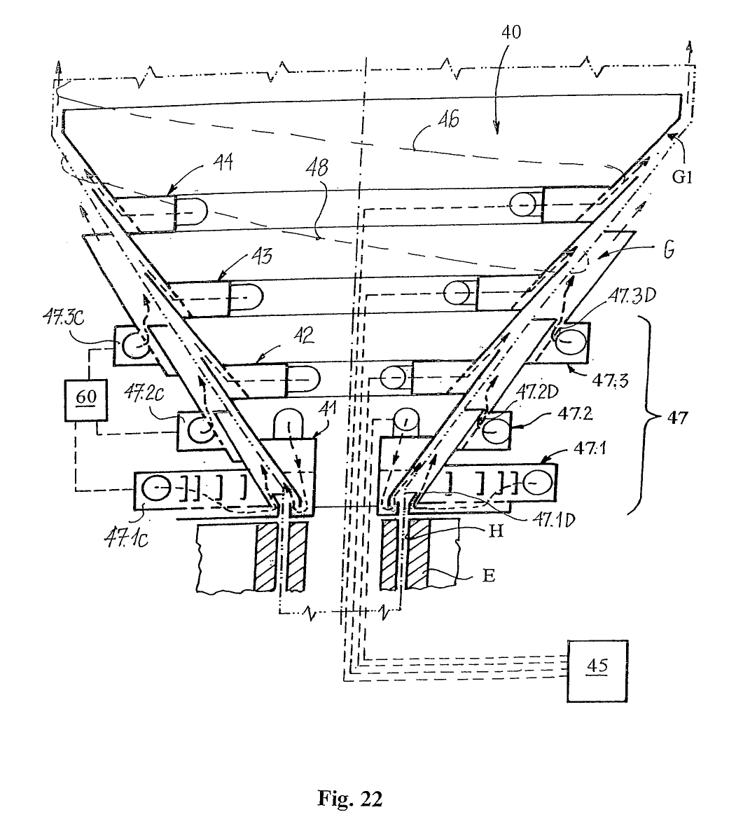

Finally, FIG. 22 shows a preferred embodiment of the foil producing apparatus according to the invention where an internal multi-level cooling and orienting device 40 (according to FIG. 7) is combined with the external multi-level foil cooling device 1 (as in FIGS. 1 to 3). Internal cooling units 41 to 44 of the internal foil cooling and orienting device 40 are fixed concentrically, overlapping each other, and in an adjustable manner compared to each other, and they are connected to a common coolant supply 45 (as discussed in connection with FIG. 7). Thereby ring-like gaps—of adjustable flow cross-section—are created between the conical directing mantles (see FIG. 7), through which controllable tangential coolant flows exit as indicated by thin arrows. These together form a spiral internal coolant flow 46 in an internal ring gap G1.

The external multi-stage foil cooling device 47 consists of three external cooling units 47.1, 47.2. and 47.3, arranged at axial distances from each other; they (corresponding mainly to the cooling units 2 to 4 according to FIG. 1) are connected to a common coolant supply 60 in an individually controllable manner. (The structural design of the lowermost cooling unit 47.1 substantially corresponds to the cooling device presented in FIG. 17).

Each of the other external cooling units 47.2 and 47.3 are equipped with a coolant distributing ring 47.2A and a cooling ring 47.3A, as well as conical directing mantles 47.2B and 47.3B, arranged in a manner overlapping each other. Each of the cooling units 47.1, 47.2 and 47.3 is equipped with inlets 47.1C to 47.3C and outlets 47.1D to 47.3D to direct regulated tangential coolant flows to the external surface of the foil hose F, i.e. into a main external ring gap G. The tangential coolant flows form an external spiral air flow 48 together, progressing from the bottom upwards along the external main ring gap G. The multi-level external foil cooling device 47 is not presented in detail as it is identical with the one presented in FIG. 1.

The efficiency of foil cooling can be improved dramatically by the joint impact of the external and internal spiral coolant flows 46 and 48, respectively.

A further advantage of the internal foil cooling and orienting device 40 of the apparatus according to the invention is that it essentially closes the internal space of the foil hose F. By this, it is meant that the foil hose F is not necessarily required to be flattened, i.e. closed, which is ensured in a traditional case by the pull-up cylinder pair, because the coolant cannot “escape” anyway through the regulated flow cross-section of the internal main ring gap G1. More specifically, only an amount of air equaling to the amount blown in for cooling is removed through the main ring gap G1, but the foil hose F will stay stable all the time. One of the advantages of this is that the foil hose F can be split into two or more parts, without being closed at the already stabilized cylindrical section, because this procedure is subject to an open foil hose.

An open foil hose is also required for a further procedure of great importance, namely shrink foil production, as already discussed in relation with FIG. 21.

Thus in the apparatus and process according to the invention, the internal foil cooling and orienting device 40 ensures several levels of blow-in in the progress direction x of the foil hose F, thereby the continuously increasing coolant demand is completely satisfied when progressing upwards along the conical non-stabilized section M. This way the long-standing problem of the prior art has been solved that the air blown in at the bottom slows down and heats up by the extension, and the gap between the balloon and the cone is reduced because ‘fresh’ air is replaced and/or supplemented in several phases, therefore the size of the internal main ring gap G1 will remain the same all the time.

It is also an important advantage that the air supply of the cooling units 41 to 44 comes from an independent and controlled coolant supply 45, thus the quantity and temperature of the coolant blown in can be changed at each level that it will not change at any of the other places. This highly facilitates control and the separability of the impact of the intervention.

In accordance with the invention, an ever greater quantity of increasingly colder air is required to completely and rapidly cool back the accelerating foil hose F cooling in the meantime while going upwards along the cooling and stabilizing conical section M. This can be achieved by the present invention as coolant can be supplied in quantities, at temperatures, and pressures individually regulated at the various height levels of the cooling device 40 to the foil hose F. Thus, the temperature and speed difference required for cooling of adequate intensity is ensured, actually by blowing in an ever greater quantity of increasingly colder air, for instance, in the most even distribution possible, into the main ring gaps G and G1.

A further advantage of the invention is that—as described above—air of different quantities and temperatures coming from a controlled source can also be blown in on the basis of the parameters of the air already inside the foil hose F. This means that in a given case, the temperature of the air arriving from below is measured before the blow-in levels, e.g. at the cooling unit 42, then the temperature of the air to be fed in there is determined as a function thereof. This way the temperature difference required for appropriate heat transfer is maintained.

On the basis of the above, it can be easily conceded that a discretionary ‘cooling map’ can be created using the technology according to the invention. This means that the quantity, speed, and temperature of the coolant can be adjusted selectively as required at any height of the cooling device, i.e. by sections at the blow-ins. This way any discretional cooling states can be generated in the knowledge of the parameters of the plastic flux and taking into consideration the foil characteristics intended to be achieved. This is of great importance because the mesh-like texture produced by blowing up, pulling up and rotating the instrument core—in case of an extruder head with a revolving core—must be fixed in this cooling section in a way that it should be completely even along the perimeter and the length.

Major advantages of the invention include the following:
As a result of the tangential coolant flows blown in from outlets or channels located at various levels, the foil hose F cools back more rapidly;
As a result of the continuously supplemented coolant, the spiral coolant stream 48, 49 does not heat up in the main ring gaps G and G1 and its cooling effect can be maintained at a permanent value;
Coolant distribution is completely even, which can also be seen from the circularity of the ring gap;
Along the generator of the non-stabilized conical section M of the foil hose F, the size of the main ring gaps G and G1 remains permanent;
The coolant flowing tangentially at a relatively high speed in the main ring gap G or G1 between the foil hose F and the conical directing mantles highly stabilizes and guides, i.e. centralizes the foil hose F;
As the internal cooling and orienting device 40 ‘closes’ the foil hose through the main ring gap G1 generated along the perimeter, it is possible to split the foil hose into strips in the stabilized cylindrical hose part;
The foil hose F is cooled at the place of orientation;
The conical directing mantle helps to guide the coolant accurately, and the foil hose is ‘supported’ by a regulated coolant flow;
It can be applied in the case of a wide range of basic materials;
It can also be used for producing shrink foil.

The multi-level internal cooling and orienting device can be applied individually or in combination with any of the external cooling devices.

Although the detailed description discloses a few embodiments of the invention only, it is to be understood that the invention is not so limited. Many modification, variations and combination thereof will now become apparent to a person skilled in the art within the claimed scope of protection.

1-15. (canceled)

16. An apparatus for continuously manufacturing extruded plastic foil hose, comprising an extruder with a die having an annular drawing orifice suitable for forming the foil hose, and an internal and/or an external cooling device surrounding said drawing orifice and at least a portion of an expanded foil hose, said internal and/or external cooling device being provided with an inlet for a coolant, preferably cooling air, and being connected to a coolant supply and at least one outlet supplying coolant into an annular gap between the expanded foil hose to be cooled and an annular skirt of said internal and/or external cooling device, wherein said internal and/or external cooling device is a multistage device, preferably arranged directly on the extruder die and coaxially with the drawing orifice and having multilevel tangential outlets for the coolant to stabilize a first conical, non-stabilized section of said expanded foil hose by an internal and/or external spiral coolant stream, said multistage internal cooling device comprising at least two internal annular cooling-orienting units arranged at axial distances from each other, at least partly internally surrounding the non-stabilized section of the foil hose through the internal main annular gap, each of the internal annular cooling-orienting units being connected to the coolant supply in such a way as to supply the coolant with selectively and individually adjustable temperature and/or volume and/or pressure, said multistage external cooling device comprising at least two annular external cooling units arranged at an axial distance from each other, at least partly externally surrounding the conical, non-stabilized section of said expanded foil hose through the external main annular gap, each external cooling-orienting unit being provided with at least one tangential inlet and being connected to a second coolant supply for feeding the coolant with selectively and individually adjustable temperature and/or volume and/or pressure.

17. An apparatus according to claim 16, comprising at least one internal multistage cooling device and at lest one external multistage cooling device.

18. An apparatus according to claim 16, wherein each of the external cooling units of said external multistage cooling device comprises at least one coolant-distributing ring having at least one conical mantle surrounding the external main annular gap, and the tangential outlets are formed in said mantles, preferably as slots, forming tangential inlet gaps for the coolant around the foil hose.

19. An apparatus according to claim 17, wherein each of the external cooling units of said external multistage cooling device comprises at least one coolant-distributing ring having at least one conical mantle surrounding the external main annular gap, and the tangential outlets are formed in said mantles, preferably as slots, forming tangential inlet gaps for the coolant around the foil hose.

20. An apparatus according to claim 16, wherein each of the internal annular cooling-orienting units comprises at least one coolant-distributing ring and at least one conical coolant baffle surrounding the internal main annular channel, and being provided with inlets and tangential outlets, preferably slots, forming tangential cooling inlets around the foil hose.

21. An apparatus according to claim 17, wherein each of the internal annular cooling-orienting units comprises at least one coolant-distributing ring and at least one conical coolant baffle surrounding the internal main annular channel, and being provided with inlets and tangential outlets, preferably slots, forming tangential cooling inlets around the foil hose.

22. Apparatus according to claim 18, wherein the cooling-orienting units and/or the conical coolant-directing mantles of the adjacent cooling-orienting units are axially arranged in such a way as to overlap each other, thereby creating ring-like caps between the adjacent mantles, and preferably the mutual axial position of the mantles, and thereby a flow cross-section of said ring-like gaps can be adjusted.

23. Apparatus according to claim 20, wherein the cooling-orienting units and/or the conical coolant-directing mantles of the adjacent cooling-orienting units are axially arranged in such a way as to overlap each other, thereby creating ring-like caps between the adjacent mantles, and preferably the mutual axial position of the mantles, and thereby a flow cross-section of said ring-like gaps can be adjusted.

24. An apparatus according to claim 18, wherein the conical mantle of said at least one external cooling-orienting unit is provided with a conical extension mantle having a relatively smaller diameter, and the relative axial position of said conical extension mantle can be adjusted with respect to the corresponding directing mantle, thereby forming a ring-like gap between the directing mantle and the extension mantle, and the flow cross-section thereof can be regulated, wherein some of the already-used coolant can be removed from the external main ring gap of the external multistage cooling device, preferably through an upper free end of the gap leading to an external open airspace.

25. An apparatus according to claim 18, wherein a flow cross-section of the ring-like coolant inlet gaps at the cooling units can be adjusted by mutual axial adjustment of the cooling rings and/or their directing mantles, and/or at the lowest cooling unit by mutual axial adjustment of its cooling ring and a lower neck thereof.

26. An apparatus according to claim 20, wherein the mutual axial position of at least two of the internal cooling-orienting units is adjustable, enabling fixed setting of their axial distances and the flow cross-section of the internal main ring gap around the foil hose.

27. An apparatus according to claim 16, wherein:
the cooling-orienting units of the internal multistage cooling device form a common cooling ring with a common internal coolant distribution space, said units having conical mantles and tangential outlets therein that form a conical mantle of said cooling ring, the coolant distribution space being closed by a top cover and a bottom plate;
a built-in fan rotor is rotatably embedded and connected to an external rotary drive within the coolant distribution space; and
the mantles of the cooling units, as well as the cover, and the bottom place jointly constitute a fan hosing, the cooling ring being provided with an inlet for supplying coolant of predetermined temperature.

28. An apparatus according to claim 20, wherein:
the cooling-orienting units of the internal multistage cooling device form a common cooling ring with a common internal coolant distribution space, said units having conical mantles and tangential outlets therein that form a conical mantle of said cooling ring, the coolant distribution space being closed by a top cover and a bottom plate;
a built-in fan rotor is rotatably embedded and connected to an external rotary drive within the coolant distribution space; and
the mantles of the cooling units, as well as the cover, and the bottom place jointly constitute a fan hosing, the cooling ring being provided with an inlet for supplying coolant of predetermined temperature.

29. An apparatus according to claim 16, wherein the internal multistage cooling device is arranged at a predetermined axial distance from the extruder die for producing foil hoses from high density plastic material, mainly polyethylene (HDPE).

30. An apparatus according to claim 16, wherein for shrink foil production:
the coil cooling device is arranged immediately over the extruder die to cool a first non-stabilized conical section of the foil hose to a predetermined degree, at an axial distance from the upper edge of the cooling device;
a heating device is located to heat up and thereby to soften again the foil hose being partially extended and oriented;
a second multistage foil cooling and orienting device is coaxially arranged directly above the heating device for final stabilizing of the foil hose.

31. A process for producing plastic foil hose, said process comprising the steps of:
surrounding at least a portion of a non-stabilized, expanded section of the foil hose just exiting from a drawing orifice of an extruder die by using an external multi-stage cooling device and thereby providing an external main ring gap at a radial distance from an external surface of the foil hose and/or by using an internal multi-stage cooling device and thereby providing an internal main ring gap at a radial distance from the internal surface of the foil hose;
supplying coolant of selectively predetermined temperature and/or pressure and/or volume, mainly cooling air, into the external and/or internal main ring gap(s) through axially multi-level tangential inlets and directing the tangential coolant streams onto the external and/or internal surface(s) of the non-stabilized section of the foil hose in order to cool externally and/or internally the non-stabilized section of the foil hose, thereby stabilizing its structure by means of generating at least one spiral coolant stream from the multi-level tangential coolant streams within said external and/or internal main ring gap(s) by using a centrifugal force affecting the coolant streams along the external and/or internal surface(s) of the expanded foil hose, and by using density and pressure differences between various parts of the coolant flows.

32. A process according to claim 31, further comprising the additional step of cutting up a tubular foil hose longitudinally at least two places, forming flat foil stripes from the foil hose during or immediately after the final stage of the cooling and stabilizing step.

33. A process according to claim 31, wherein internal tangential coolant flows supplied by the selectively controllable coolant supply of the internal multistage internal cooling device is used to inflate the foil hose, thereby stretching and orienting the hose in cross section.

34. A process according to claim 32, wherein internal tangential coolant flows supplied by the selectively controllable coolant supply of the internal multistage internal cooling device is used to inflate the foil hose, thereby stretching and orienting the hose in cross section.

35. A process according to claim 31, comprising for shrink foil production first cooling a non-stabilized conical section of the foil hose to a predetermined degree to partially stabilize said foil hose; then heating up to thereby soften again the foil material and, directly after the heating step, completely stabilizing the foil hose by using a second multistage foil cooling and orienting device.
